(19) United States
(12) Patent Application Publication
(10) Pub. No.: US 2026/0166864 A1
(43) Pub. Date: Jun. 18, 2026

(54) COMPOSITE FIRE INSULATION SHEET, COMPOSITE PLATE, BATTERY PACK HOUSING, AND BATTERY PACK

(71) Applicant: Owens Corning Intellectual Capital, LLC, Toledo, OH (US)

(72) Inventors: Tengfei HE, Hangzhou, Zhejiang (CN); Jinchun ZHU, Hangzhou, Zhejiang (CN); Tianhong ZHANG, Hangzhou, Zhejiang (CN)

(21) Appl. No.: 19/119,800

(22) PCT Filed: Apr. 5, 2024
(86) PCT No.: PCT/US2024/023183

§ 371 Date: Apr. 10, 2025

(30) Foreign Application Priority Data
Apr. 23, 2023 (CN) 202320938364.9

(51) Int. Cl. B32B 27/12; B32B 5/18; B32B 5/26

(52) U.S. Cl. CPC B32B 27/12; B32B 5/18; B32B 5/26; B32B 2262/101; B32B 2307/102

(57) ABSTRACT

The present application discloses a composite fire insulation sheet, a composite plate, a battery pack housing and a battery pack. The composite fire insulation sheet comprises a first glass fiber sheet and a first aerogel composite expansion fire insulation layer. The first aerogel composite expansion fire insulation layer is arranged on at least one surface of the first glass fiber sheet and has a second glass fiber sheet. According to the composite fire insulation sheet of this application, the expansion fireproof composition plays the role of flame retardant and fire prevention, while the aerogel composition is used to endow the sheet with excellent heat insulation property, such that the sheet can also perform the strong heat insulation performance.

### CROSS-REFERENCE TO RELATED APPLICATION(S)

This application claims priority to Chinese Patent Application No. 202320938364.9 filed on Apr. 23, 2023, now Chinese Patent No. Patent No. ZL202320938364.9, the disclosure of which is incorporated by reference herein in its entirety.

### BACKGROUND

The present application relates to the technical field of composite materials, and specifically to a composite fire insulation sheet, a composite plate, a battery pack housing, and a battery pack.

With the increasing penetration rate of new energy vehicles, the safety of new energy vehicles, particularly the safety of power batteries, deserves more and more attention.

The current power batteries are mostly ternary lithium batteries or lithium iron phosphate batteries. If the power battery is damaged, it may cause thermal runaway, resulting in a large number of flames. The battery cover of this type of power batteries is partially made of organic composite material. The material is unable to withstand the flames caused by the thermal runaway of the power battery, and it will soon deform and even burn, producing a large amount of toxic and harmful smoke and threatening the occupants of vehicles.

Therefore, the battery pack of the current power battery has problems such as poor heat insulation and flame resistance of the battery cover plate, which cannot effectively prevent the flame burning caused by the thermal runaway of batteries.

Therefore, a composite fire insulation sheet, a composite plate, a battery pack housing, and a battery pack are needed to at least partially solve the above problems.

### SUMMARY

A series of simplified concepts is introduced into the portion of Summary, which would be further illustrated in the portion of the detailed description. The Summary of the present application does not mean attempting to define the key feature and essential technical feature of the claimed technical solution, let alone determining the protection scope thereof.

To at least partially solve the problems, the first aspect of the present application provides a composite fire insulation sheet, comprising:
a first glass fiber sheet;
a first aerogel composite expansion fire insulation layer arranged on at least one surface of the first glass fiber sheet and having a second glass fiber sheet.

According to the composite fire insulation sheet of this application, the expansion fireproof composition plays the role of flame retardant and fire prevention, while the aerogel composition is further used to endow the sheet with excellent heat insulation property, such that the sheet can also perform the strong heat insulation performance.

Optionally, the first aerogel composite expansion fire insulation layer has a thickness of 0.3 mm˜2.0 mm. According to the above settings, the thickness of the thicker first aerogel composite expansion fire insulation layer can realize stronger fireproofing and thermal insulation property.

Optionally, the composite fire insulation sheet further comprises a self-adhesive layer.

The first aerogel composite expansion fire insulation layer is arranged on one surface of the first glass fiber sheet, and the self-adhesive layer is arranged on the other surface of the first glass fiber sheet, or
the first aerogel composite expansion fire insulation layer is arranged two surfaces of the first glass fiber sheet, and the self-adhesive layer is arranged on a surface of the first aerogel composite expansion fire insulation layer on one surface of the first glass fiber sheet, or
the first aerogel composite expansion fire insulation layer is arranged on one surface of the first glass fiber sheet, the other surface of the first glass fiber sheet is provided with a second aerogel composite expansion fire insulation layer, and the self-adhesive layer is arranged on a surface of the second aerogel composite expansion fire insulation layer. Thus, the composite fire insulation sheet can be easily applied to the application scenarios.

Optionally, the composite fire insulation sheet further comprises a release layer arranged on a surface of the self-adhesive layer. According to the above settings, it is convenient for the packaging and application of the composite fire insulation sheet.

Optionally, the composite fire insulation sheet is provided with a cutting contour line that has a plurality of incisions running through the composite fire insulation sheet. According to the above settings, it is conducive to operators' construction.

The second aspect of the present application provides a composite plate, comprising:
a matrix;
the composite fire insulation sheet of the first aspect arranged on at least one surface of the matrix.

The composite plate according to this application comprises the composite fire insulation sheet of the first aspect, which can achieve a technical effect similar to that of the composite fire insulation sheet of the first aspect. Moreover, the composite fire insulation sheet can effectively protect the matrix, reduce the possibility of deformation and combustion of the matrix in the face of high temperature and flame, and improve the lifetime thereof.

Optionally, the composite plate further comprises a primer layer arranged between the matrix and the composite fire insulation sheet. Thus, the bonding firmness of the composite fire insulation sheet can be improved.

Optionally, the primer layer has a thickness of 0.05˜0.2mm. Thus, the adhesion can be further improved.

The third aspect of the present application provides a battery pack housing, comprising:
the composite fire insulation sheet of the first aspect; or
the composite plate of the second aspect.

The battery pack housing according to this application comprises the composite fire insulation sheet of the first aspect, which can achieve a technical effect similar to that of the composite fire insulation sheet of the first aspect.

The fourth aspect of the present application provides a battery pack, comprising:
the composite fire insulation sheet of the first aspect; or
the composite plate of the second aspect; or
the battery pack housing of the third aspect;
wherein the first aerogel composite expansion fire insulation layer is disposed toward a power battery in the battery pack.

The battery pack according to this application comprises the composite fire insulation sheet of the first aspect, which can achieve a technical effect similar to that of the composite fire insulation sheet of the first aspect.

### BRIEF DESCRIPTION OF THE DRAWINGS

The following drawings are hereby incorporated as part of the present application for the understanding of the application. The embodiments are illustrated and described in the drawings in order to explain the principles of the present application.

In the drawings:

FIG. 1 shows a structure diagram of a composite fire insulation sheet according to an embodiment of the present application:

FIG. 2 shows a structure diagram of a composite fire insulation sheet according to another embodiment of the present application;

FIG. 3 shows a structure diagram of a composite fire insulation sheet according to an alternative embodiment of the present application;

FIG. 4 shows a structure diagram of a composite fire insulation sheet according to another alternative embodiment of the present application;

FIG. 5 shows a structure diagram of a composite plate according to an embodiment of the present application, wherein the composite fire insulation sheet shown in FIG. 2 is used;

FIG. 6 shows a structure diagram of a composite plate according to an embodiment of the present application, wherein the composite fire insulation sheet shown in FIG. 3 is used;

FIG. 7 shows a structure diagram of a composite plate according to an embodiment of the present application, wherein the composite fire insulation sheet shown in FIG. 4 is used; and

FIG. 8 shows a structure diagram of a battery pack according to an embodiment of the present application; and

FIG. 9 shows a top view schematic of a composite fire insulation sheet according to an embodiment of the present application.

### DETAILED DESCRIPTION

In the following description, numerous specific details are set forth in order to provide a more thorough understanding of the present application. However, it is obvious to those skilled in this art that the present application may be implemented without one or more of these details. Some technical features well-known in this art are not described in other examples in order to avoid confusion with the present application.

It shall be noted that the terminology used herein is for the purpose of describing particular embodiments only and is not intended to limit the exemplary embodiments of the present application. As used herein, the singular forms are intended to include the plural forms as well, unless the context clearly indicates otherwise. It will be further understood that the terms “comprising” and/or “including,” when used in this specification, specify the presence of stated features, wholes, steps, operations, elements, and/or components, but do not preclude the presence or addition of one or more other features, wholes, steps, operations, elements, components, and/or combinations thereof.

Ordinals such as “first” and “second” quoted in this application are merely identifiers and do not carry any other meaning, such as a specific order. Moreover, for example, the term “first component” itself does not imply the presence of “second component”, and the term “second component” itself does not imply the presence of “first component”. It should be noted that the terms “up”, “down”, “front”, “back”, “left”, “right”, “inside”, “outside” and similar expressions used herein are for illustrative purposes only and are not restrictive.

The exemplary embodiments of the present application will now be explained in further details with reference to the accompanying drawings.

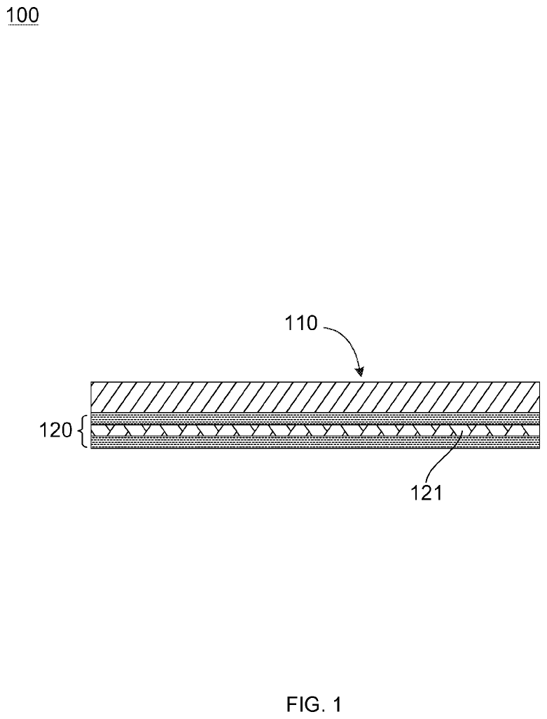

With reference to FIG. 1, the first aspect of the application provides a composite fire insulation sheet 100, comprising a first glass fiber sheet 110 and a first aerogel composite expansion fire insulation layer 120, wherein, the first aerogel composite expansion fire insulation layer 120 is arranged on at least one surface of the first glass fiber sheet 110 and has a second glass fiber sheet 121.

Specifically, the first aerogel composite expansion fire insulation layer 120 is formed by coating the aerogel composite expansion fire insulation coating on the grid cloth and permeating the aerogel composite expansion fire insulation coating into the grid. That is, the grid cloth is an example of the second glass fiber sheet 121. Wherein, the aerogel composite expansion fire insulation coating may be an expansion fire insulation coating that is added with aerogel composition. Further, the aerogel composite expansion fire insulation coating can be an expansion fire insulation coating that is added with silicon dioxide aerogel composition.

According to the composite fire insulation sheet 100 of this application, the expansion fireproof composition plays the role of flame retardant and fire prevention, while the aerogel composition is further used to endow the sheet with a strong heat insulation property, such that the sheet can also perform the strong heat insulation performance. The composite fire insulation sheet 100 according to the application can resist the flame impact of more than 15 min without destroying, and especially the smoke generated by expansion and flame retardant of the inorganic system is also little.

In this embodiment, the first aerogel composite expansion fire insulation layer 120 is arranged on one surface of the first glass fiber sheet 110 only. The reason is that when the material density of the first glass fiber sheet 110 is higher, the aerogel composite expansion fire insulation coating can not penetrate into the first glass fiber sheet 110, or can only partially penetrate into the first glass fiber sheet 110 but can not reach the other surface of the first glass fiber sheet 110.

The above first glass fiber sheet 110 can choose alkali-free continuous glass fiber fabric, such as glass fiber plaid cloth, glass fiber woven cloth, glass fiber mesh cloth, glass fiber warp-knitted fabric, glass fiber 3d mesh fabric or glass fiber plaid cloth felt with relatively high mechanical strength resistance. Alternatively, the above first glass fiber sheet 110 can also choose discontinuous glass fiber felt or glass fiber non-woven fabric, or the like. In addition, the first glass fiber sheet 110 may also be a glass fiber warp-knit composite fabric made by laminating a discontinuous glass fiber felt with a glass fiber warp-knit fabric. Preferably, the first glass fiber sheet 110 is selected from glass fiber woven cloth, glass fiber nonwoven fabric or glass fiber warp-knitted composite fabric.

The second glass fiber sheet 121 can choose alkali-free continuous glass fiber fabric, such as glass fiber mesh cloth, glass fiber woven cloth or glass fiber plaid cloth. Alternatively, the second glass fiber sheet 121 can also choose discontinuous glass fiber felt or glass fiber non-woven fabric, or the like. Preferably, the second glass fiber sheet 121 is selected from glass fiber mesh cloth, discontinuous glass fiber felt or glass fiber nonwoven fabric.

Further, the second glass fiber sheet 121 has a greater ability to absorb the coating/glue than the first glass fiber sheet 110.

As an implementation, the first aerogel composite expansion fire insulation layer 120 can have a thickness of 0.3 mm to 2.0 mm. Thus, the thickness of the thicker first aerogel composite expansion fire insulation layer 120 can realize stronger fireproofing and insulation performance. Further, the first aerogel composite expansion fire insulation layer 120 can have a thickness of 0.4 mm˜1.5 mm. Therefore, moderate thickness is economic and occupies a relatively lower space while enabling to perform a strong fireproof and thermal insulation performance.

Moreover, when the glass fiber sheet 110 uses non-woven and the thickness of the first aerogel composite expansion fire insulation layer 120 is proper, the composite fire insulation sheet 100 can be endowed with good flexibility, making it easier to be applied in the application scenarios, with better operability.

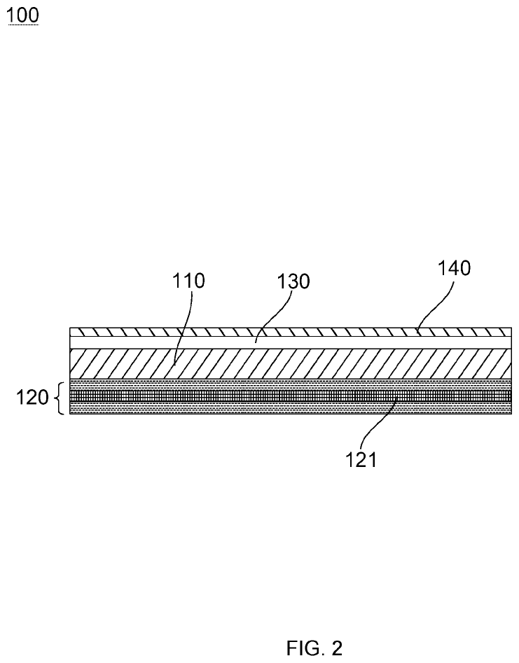

Below is reference to FIG. 2. The composite fire insulation sheet 100 further comprises a self-adhesive layer 130 arranged on the other surface of the first glass fiber sheet 110. In other words, the two sides of the first glass fiber sheet 110 are respectively provided with a self-adhesive layer 130 and a first aerogel composite expansion fire insulation layer 120. The adhesive selected in the self-adhesive layer 130 is a heat-resistant adhesive. Thus, the composite fire insulation sheet 100 can be easily applied to the application scenarios.

Continuing with reference to FIG. 2, the composite fire insulation sheet 100 further comprises a release layer 140 arranged on a surface of the self-adhesive layer 130. When the composite fire insulation sheet 100 needs to be paved, only the release layer 140 is removed for construction. In this way, it is convenient for the packaging and application of the composite fire insulation sheet 100.

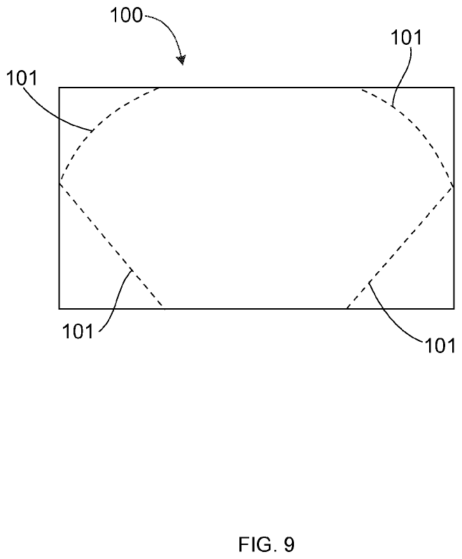

In order to further improve convenience of construction in use, referring to FIG. 9, the composite fire insulation sheet 100 may be provided with a cutting contour line 101 that has a plurality of incisions running through the composite fire insulation sheet 100, so that operators can directly tear the composite fire insulation sheet 100 from the cutting contour line 101 or cut it easily. The above cutting contour lines 101 can include pre-designed lines of different shapes depending on various application scenarios. Alternatively, the above cutting contour lines 101 can also be used as a crease without cutting. For example, the above cutting contour lines 101 are used to form creases at certain locations with steps, allowing the composite fireproof insulation sheet 100 to fit more conformably.

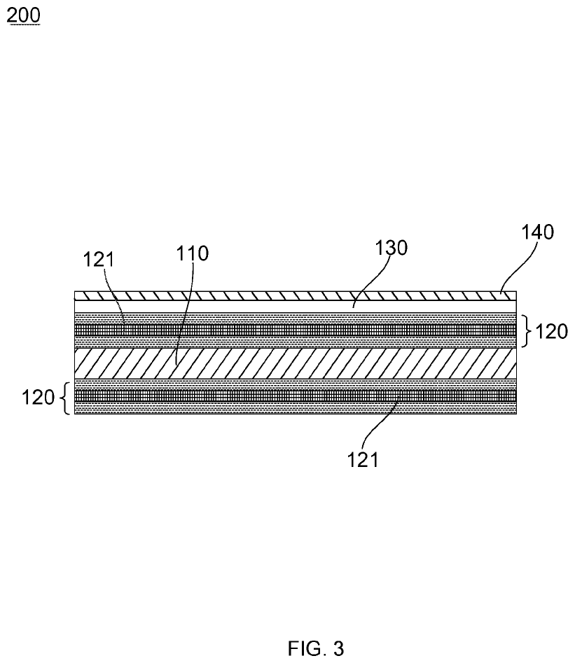

As an alternative embodiment, referring to FIG. 3, in the composite fire insulation sheet 200, the first aerogel composite expansion fire insulation layer 120 can be arranged on two surfaces of the first glass fiber sheet 110. In this case, the self-adhesive layer 130 is arranged on the surface of the first aerogel composite expansion fire insulation layer 130 on one surface of the first glass fiber sheet 110. In this embodiment, the first glass fiber sheet 110 can choose the material with higher density. The first aerogel composite expansion fire insulation layer 120 is applied on two surfaces of the first glass fiber sheet 110, respectively, and the aerogel composite expansion fire insulation coating thereby will not penetrate or only partially penetrate into the first glass fiber sheet 110.

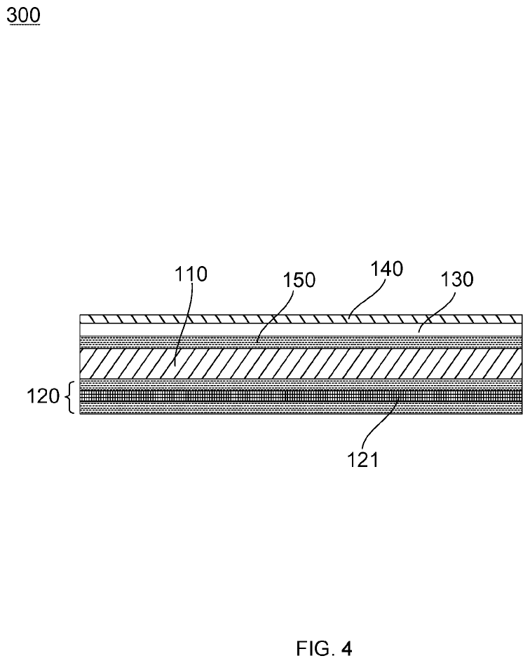

As another alternative embodiment, referring to FIG. 4, in the composite fire insulation sheet 300, the first aerogel composite expansion fire insulation layer 120 can be arranged on one surface of the first glass fiber sheet 110. The other surface of the first glass fiber sheet is provided with a second aerogel composite expansion fire insulation layer, and the self-adhesive layer is arranged on the surface of the second aerogel composite expansion fire insulation layer. In this embodiment, when the first glass fiber sheet 110 can choose the material with higher density, the aerogel composite expansion fire insulation coating will not penetrate or only partially penetrate into the first glass fiber sheet 110. Therefore, it is necessary to apply the first aerogel composite expansion fire insulation layer 120 and the second aerogel composite expansion fire insulation layer 150 on both sides of the first glass fiber sheet 110. When the material density of the first glass fiber sheet 110 is low, the aerogel composite expansion fire insulation coating can penetrate through the first glass fiber sheet 110 and reach the other surface of the first glass fiber sheet 110, thus forming the second aerogel composite expansion fire insulation layer 150, wherein the second aerogel composite expansion fire insulation layer 150 is not provided with the second glass fiber sheet.

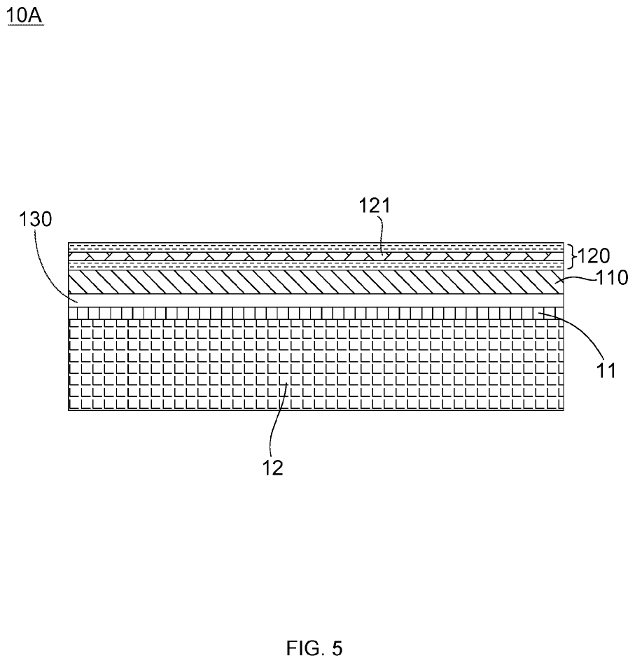

The second aspect of the application provides a composite plate 10A. With reference to FIG. 5 to FIG. 7, the composite plate 10A shown in FIG. 5 comprises a matrix 12 and the composite fire insulation sheet 100 of the first aspect arranged on at least one surface of the matrix 12. In other words, the composite fire insulation sheet 100 is laid and pasted on the matrix 12 to form the composite plate 10A, wherein the matrix 12 can be prepreg composite material such as epoxy resin glass fiber composite. The side of the composite plate 10A provided with the composite fire insulation sheet 100 is constructed to face the possible production position of the flame/heat source.

The composite plate 10A according to this application comprises the composite fire insulation sheet 100 of the first aspect, which can achieve a technical effect similar to the composite fire insulation sheet 100 of the first aspect. Moreover, the composite fire insulation sheet 100 can effectively protect the matrix 12, reduce the possibility of deformation and combustion of matrix 12 in the face of high temperature and flame, and improve the lifetime thereof.

As an implementation, the composite plate 10A further comprises a primer layer 11 arranged between the matrix 12 and the composite fire insulation sheet 100. Thus, the adhesion of the composite fire insulation sheet can be improved. In order to further improve the adhesion of the composite fire insulation sheet 100, the thickness of the primer layer 11 can be set to 0.05 mm to 0.2 mm. The primer layer 11 can include any type of primer or sealer. An ethyl acetate primer, such as Sika Primer type 94 primer, is just one example of such a primer.

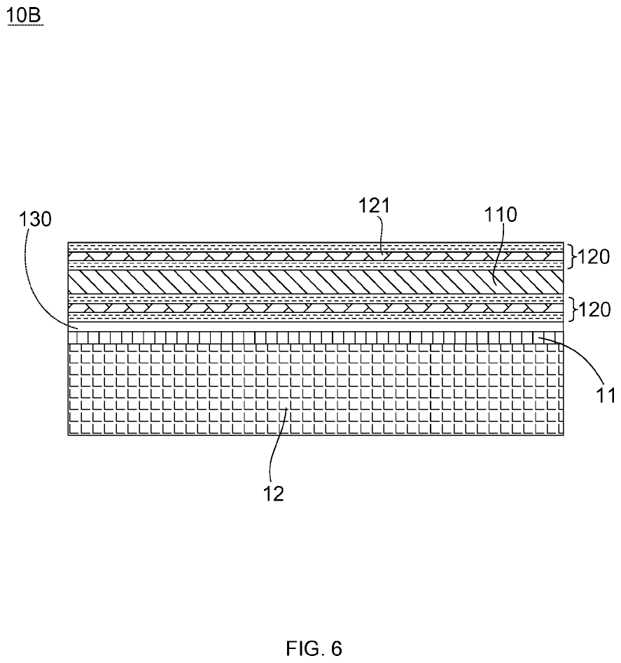

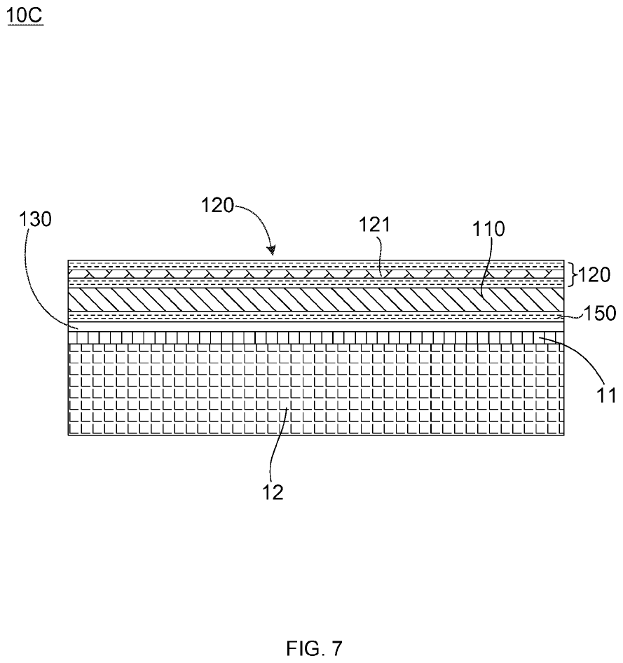

In addition to the composite fire insulation sheet, the structure of the composite plate 10B in FIG. 6 and that of the composite plate 10C in FIG. 7 can be similar to the structure of the composite plate 10A in FIG. 5, but can also have different configurations, thickness, configurations, layouts, and more, of which is not detailed here.

The third aspect of the application provides a battery pack housing 20 for a battery pack 1, comprising the composite fire insulation sheet of the first aspect or the composite plate of the second aspect. In other words, the composite plate can be used to manufacture the battery pack housing 20 of the battery pack 1. The composite plate according to this application comprises the composite fire insulation sheet 100 of the first aspect, which can achieve a technical effect the same as or similar to that of the composite fire insulation sheet 100 of the first aspect.

The fourth aspect of the application provides a battery pack 1, comprising the composite fire insulation sheet of the first aspect or the composite plate of the second aspect or the battery pack housing 20 of the third aspect. In other words, the battery pack housing 20 of the third aspect can be used to manufacture the battery pack 1.

The battery pack 1 according to this application comprises the composite fire insulation sheet 100 of the first aspect, which can achieve a technical effect the same as or similar to that of the composite fire insulation sheet 100 of the first aspect.

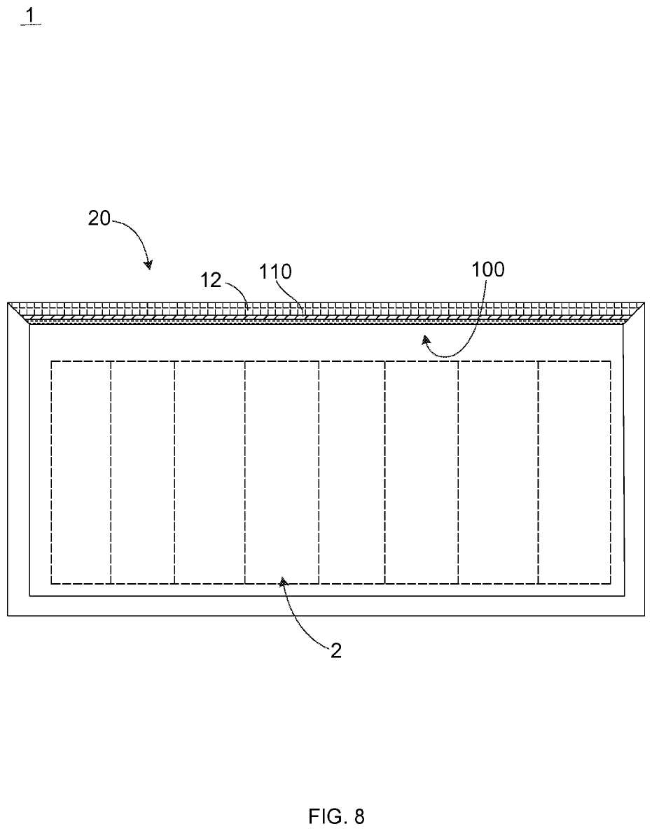

With reference to FIG. 8, wherein the battery pack 1 is provided with a single battery or a battery cell. The composite fire insulation sheet 100 on the battery pack housing 20 is arranged inside the battery pack 1, that is, the composite fire insulation sheet 100 is laid and pasted on the inner side surface of the battery pack housing 20. Moreover, the first aerogel composite expansion fire insulation layer 120 of the composite fire insulation sheet 100 is disposed toward the power battery 2.

Therefore, when the flame is generated by thermal runaway of batteries in the battery pack 1, the first aerogel composite expansion fire insulation layer 120 faces the flame, blocks the flame with its own fireproof performance, and uses its thermal insulation property to prevent the temperature of the matrix 12 of the battery pack housing 20 in the battery pack 1 from being too high. As a result, it can not only effectively prevent the matrix 12 of the battery pack housing 20 from producing harmful smoke at high temperature, but also can reduce the actual temperature difference withstood by the battery pack housing 20 in the course of daily use, which further reduces the aging speed caused by the impact of temperature change on the matrix 12 of the battery pack housing 20 and improves the service life of the battery pack housing 20.

Unless otherwise defined, the technical and scientific terms used herein have the same meanings as commonly understood by those skilled in the technical field of the present application. The terms used herein are only for describing specific implementation purposes, and are not intended to limit the present application. A feature described in one embodiment herein can be applied to another embodiment alone or in combination with other features, unless the feature is not applicable in the other embodiment or otherwise stated.

The present application has been described through the above-mentioned embodiments, but it should be understood that the above-mentioned embodiments are only for the purpose of illustration and description, and the present application is not limited to the embodiments. More variations and modifications can be made according to the teachings of the present application, and these variations and modifications fall within the protection scope claimed by the present application.

1. A composite fire insulation sheet, comprising:
a first glass fiber sheet; and
a first aerogel composite expansion fire insulation layer arranged on at least one surface of the first glass fiber sheet and having a second glass fiber sheet.

2. The composite fire insulation sheet of claim 1, wherein the first aerogel composite expansion fire insulation layer has a thickness of about 0.3 mm to about 2.0 mm.

3. The composite fire insulation sheet of claim 1, wherein the composite fire insulation sheet further comprises a self-adhesive layer, and
wherein; one of:
(i) the first aerogel composite expansion fire insulation layer is arranged on one surface of the first glass fiber sheet, and the self-adhesive layer is arranged on the other surface of the first glass fiber sheet;
(ii) the first aerogel composite expansion fire insulation layer is arranged on two surfaces of the first glass fiber sheet, and the self-adhesive layer is arranged on a surface of the first aerogel composite expansion fire insulation layer on one surface of the first glass fiber sheet; and
(iii) the first aerogel composite expansion fire insulation layer is arranged on one surface of the first glass fiber sheet, the other surface of the first glass fiber sheet is provided with a second aerogel composite expansion fire insulation layer, and the self-adhesive layer is arranged on a surface of the second aerogel composite expansion fire insulation layer.

4. The composite fire insulation sheet of claim 3, wherein the composite fire insulation sheet further comprises a release layer arranged on a surface of the self-adhesive layer.

5. The composite fire insulation sheet of any one of claim 1, wherein the composite fire insulation sheet is provided with a cutting contour line that has a plurality of incisions running through the composite fire insulation sheet.

6. A composite plate, comprising:
a matrix; and
a composite fire insulation sheet comprising:
a first glass fiber sheet; and
a first aerogel composite expansion fire insulation layer arranged on at least one surface of the first glass fiber sheet and having a second glass fiber sheet;
wherein the composite fire insulation sheet is arranged on at least one surface of the matrix.

7. The composite plate of claim 6, wherein the composite plate further comprises a primer layer arranged between the matrix and the composite fire insulation sheet.

8. The composite plate of claim 7, wherein the primer layer has a thickness of about 0.05 mm to about 0.2 mm.

9. A battery pack housing, comprising at least one of:
a composite fire insulation sheet comprising:
a first glass fiber sheet; and
a first aerogel composite expansion fire insulation layer arranged on at least one surface of the first glass fiber sheet and having a second glass fiber sheet; and
a composite plate comprising:
a matrix; and
the composite fire insulation sheet;
wherein the composite fire insulation sheet is arranged on at least one surface of the matrix.

10. (canceled)
